(19) United States
(12) Patent Application Publication
(10) Pub. No.: US 2017/0236236 A1
(43) Pub. Date: Aug. 17, 2017

(54) Method and System to Conduct a Multi-Jurisdictional Lottery Rewards Program

(71) Applicant: Scientific Games International, Inc., Newark, DE (US)

(72) Inventor: Amanda Francis Saferin, Fort Worth, TX (US)

(21) Appl. No.: 15/044,349

(22) Filed: Feb. 16, 2016

(51) Int. Cl. G06Q 50/34; G06K 7/14; G06K 7/10; G06Q 30/02; G07F 17/32

(52) U.S. Cl. CPC G06Q 50/34; G06Q 30/0229; G07F 17/329; G06K 7/10554; G06K 7/1413

(57) ABSTRACT

A computer-implemented method implements a loyalty program across multiple lottery jurisdictions, wherein each jurisdiction issues lottery tickets with one or more barcode formats. A database is created that includes a library of the different lottery ticket barcode formats issued by each lottery jurisdiction, and is updated at defined time intervals with the current barcode formats used in the different jurisdictions. For entry into the loyalty program, an interface allows consumers from the various lottery jurisdictions to scan a barcode from a lottery ticket purchased in one of the lottery jurisdictions and transmit the scanned barcode image to a processor. The processor compares format of the scanned barcode in the transmitted image to a library of barcode formats. The processor credits an account in the loyalty program assigned to the consumer with credit for the scanned lottery ticket only if the format of the scanned barcode matches one of the barcode formats saved in the database.

### FIELD OF THE INVENTION

The present invention relates to a multi-jurisdictional program that rewards lottery players in the various jurisdictions for buying lottery tickets.

### BACKGROUND

Lottery games have become a time honored method of raising revenue for state and federal governments the world over. Traditional scratch-off and draw games have evolved over decades, supplying increasing revenue year after year. However, after decades of growth, the sales curves associated with traditional games seem to be flattening out. Consequently, both lotteries and their service providers are continuously searching for new methods of increasing sales.

One such method for making lottery play more attractive and increasing ticket sales are “second-chance” promotions implemented in various lottery jurisdictions in the United States wherein players register losing lottery tickets online for entry into a second-chance lottery drawing. Reference is made, for example, to the Georgia Lottery Players Club program.

Lottery loyalty programs are also widely used in the industry. With these programs, players register their losing lottery tickets in a program to accumulate points that can be redeemed for merchandise, other lottery tickets, or the like. Reference is made, for example, to the MyLotto Rewards™ program from the Ohio lottery.

In the United States, “Lottery Rewards™” is an application (“app”) based business venture (www.lotteryrewards.com) wherein consumers download an app to a mobile device. This app allows for scanning of draw game or scratch-off lottery tickets from any U.S. state lottery into a program where the consumer is automatically entered into a daily drawing for a defined prize. The consumer also receives reward points than can be used to enter into more drawings. The tickets are entered by scanning the barcode printed on the ticket, regardless of the type of barcode. However, a perceived problem with the Lottery Rewards™ app is that the program cannot determine if the scanned barcode is actually from a lottery ticket. Although the same code cannot be scanned twice, users of the app are able to scan almost any kind of 2D barcode into the app, such as barcodes on food products, moving boxes, airline checked bag receipts, sample lottery tickets, and multiple codes on the same lottery ticket. This issue is detrimental to promoting the Loyalty Rewards™ program as a means to generate increased lottery ticket sales.

Thus, it is highly desirable to develop a lottery loyalty program that operates effectively across multiple jurisdictions, is based on barcodes applied to the lottery tickets, yet is not susceptible to fraud or misuse.

### SUMMARY OF THE INVENTION

Objects and advantages of the invention will be set forth in part in the following description, or may be obvious from the description, or may be learned through practice of the invention.

In accordance with aspects of the invention, a computer-implemented method is provided for implementing a loyalty program across multiple lottery jurisdictions, wherein each jurisdiction issues lottery tickets with one or more barcode formats. The program is implemented across multiple lottery jurisdictions, for example multiple states within the United States that conduct separate and independent primary lottery games, in that players or consumers can participate in the loyalty program merely by purchase of a lottery ticket in any lottery jurisdiction that is “recognized” or supported by the loyalty program (as described in greater detail below). The program can be implemented with or without active support or participation by the respective lottery jurisdictions. In this regard, the term “multi-jurisdiction” is used herein to encompass separate jurisdictional entities, such as separate states within the United States, separate countries that cooperate in a common lottery game, and generally any combination of entities that govern the lottery gaming rules and regulations within their respective borders.

The method includes creating and maintaining a special purpose computer database that includes a library of the different lottery ticket barcode formats issued by each lottery jurisdiction supported by the program. For example, the loyalty program may support three state lotteries (e.g., Georgia Lottery, South Carolina Lottery, and Florida Lottery), wherein each of these lotteries issues lottery tickets in one or more barcode formats. For example, the Georgia Lottery may issue scratch-off lottery tickets having a first barcode format, such as a 2D, 13-digit number formatted as a 3-digit game number followed by a ticket specific 10-digit validation number. The Georgia Lottery may also issue draw-type printed tickets with a different format, such as a 2D, 14 digit number formatted as a 4-digit game number followed by a ticket-specific 10-digit validation number. Another jurisdiction, such as the Florida Lottery, may use the same or completely different types of barcode formats for the lottery tickets issued to players in Florida.

Thus, for each lottery jurisdiction, the library contains a record of each of the different types of barcode formats used by the jurisdiction on tickets sold within the jurisdiction. It should be appreciated that the present method is not limited to any number or jurisdictions, or number of barcode formats within any particular jurisdiction.

It should also be appreciated, that purposes of aspects of the present method, the actual informational content of the barcode, such as the actual game number or validation number, need not be discerned from the barcode, but only the format of the barcode. The method recognizes that lottery ticket barcode formats are generally unique to lottery tickets and are not likely to be used on, for example, food products or other consumer items.

The method includes, at defined time intervals, updating the database with the current barcode formats used in the different jurisdictions. This step may be performed with or without the active participation of the respective lottery jurisdictions.

For entry into the loyalty program, the method provides an interface for players or consumers from the various lottery jurisdictions to scan a barcode from a lottery ticket purchased in one of the lottery jurisdictions and transmit the scanned barcode image to a processor. The term “processor” is used herein to encompass the hardware/software configuration of an entity that executes and manages the loyalty rewards program. The database having the library of stored barcode formats may be an integral component of this processor, or the processor may be separate from and in communication with the database.

With the processor, the method includes comparing the format of the scanned barcode in the transmitted image received by the processor to the library of barcode formats. If the format of the scanned barcode matches one of the barcode formats saved in the database, then the processor credits an account in the loyalty program assigned to the consumer with credit for the scanned lottery ticket. This “credit” may be in the form of points that can be redeemed by the consumer for any manner of goods or services, such as additional lottery tickets, merchandise, discounts at local retail establishments, and so forth.

In a particular embodiment, the interface is provided to the consumer by way of an application that is downloaded to the consumer's mobile smart device that is communication with the processor via a suitable communications network, such as the Internet, or other type of network-connected device capable of scanning and/or manual entry operations, such as a tablet, PC, or the like. The app may prompt the consumer to enter (e.g., via a screen or keypad) the identity of the jurisdiction in which the lottery ticket was purchased prior to or after scanning the barcode from the lottery ticket, wherein the processor then compares the format of the scanned barcode to only the barcode formats saved in the library assigned to the identified jurisdiction.

In an alternate embodiment, the identity of the jurisdiction in which the lottery ticket was purchased is identified in the scanned image of the barcode transmitted to the processor. For example, the scanned image may include a plain-text identifier of the jurisdiction adjacent the barcode. In still another embodiment, the identity of the jurisdiction is provided within the scanned barcode, wherein the processor is further configured to recognize the jurisdiction identity from the scanned barcode.

In certain embodiments, the different lottery jurisdictions may actively participate in the program at least to the extent that they provide the processor with periodic update information regarding new or deleted barcode formats used in the jurisdiction. In this regard, the processor is in communication with a respective processor from each of the lottery jurisdictions, wherein the processor updates the database with the current barcode formats based on communications from the lottery jurisdiction processors.

In the event that a scanned barcode image received by the processor cannot be associated by the processor to a library in the database, the received image is rejected by the processor and is not valid for credit in the loyalty program.

In certain embodiments, the processor may also perform a barcode validation check of the scanned barcode to ensure that the scanned barcode was not previously submitted. This step prevents multiple entry of the same lottery ticket into the loyalty rewards program. The validation check can be performed in various ways. For example, the validation check may involve the processor comparing content of the actual barcode to a database of previously submitted barcodes. In one embodiment, the processor may read the validation number portion of the barcode and determine if this number was previously submitted.

The present invention also encompasses various system hardware and software configurations that implement the method embodiments discussed above and described in greater detail below.

### BRIEF DESCRIPTION OF THE DRAWINGS

FIG. 1 is an illustration of a draw-type lottery ticket for entry into a loyalty rewards program in accordance with aspects of the present invention;

FIG. 2A is an illustration of a generic scratch-off lottery ticket for entry into the loyalty rewards program;

FIG. 2B depicts a 2D barcode that may be provided on a lottery ticket in accordance with the invention;

FIG. 2C depicts a 3D barcode that may be provided on a lottery ticket in accordance with the invention; and

FIG. 3 is a schematic view of an exemplary system and method for implementing the loyalty rewards program in accordance with aspects of the present invention.

### DETAILED DESCRIPTION

Reference will now be made in detail to embodiments of the inventive methods and systems, one or more examples of which are illustrated in the drawings. Each embodiment is presented by way of explanation of the invention, and not as a limitation of the invention. For example, features illustrated or described as part of one embodiment may be used with another embodiment to yield still a further embodiment. It is intended that the present invention include these and other modifications and variations as come within the scope and spirit of the invention.

In general, the present disclosure is directed to systems and methods for implementing a lottery rewards program based on entry of barcodes form lottery tickets validly purchased in different lottery jurisdictions supported by the program.

As the name implies, the loyalty rewards program provides players or consumers (referred to generically herein as “consumers”) with a means to accumulate points or other type of value simply for purchasing lottery tickets (regardless of the win/lose status of the tickets), thereby providing an incentive to consumers to purchase additional tickets. The particulars of how the rewards program is administered, such as point values or redemption process, are not particularly important to the present method and system and, in this regard, it should be appreciated that the inventions encompasses any manner of particular rewards program.

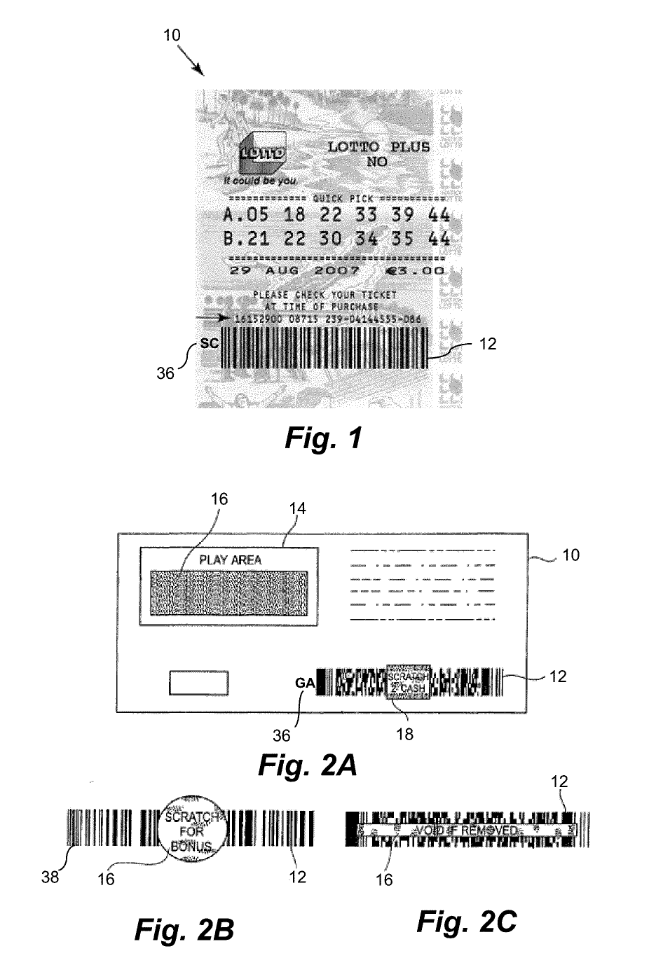

The loyalty rewards program is ticket-based in that it requires consumers to enter proof of purchase of lottery tickets validly purchased in a supported lottery jurisdiction. The invention is not limited to a particular types of lottery tickets. For example, FIG. 1 illustrates a generic draw-type lottery ticket 10 that is printed at a lottery terminal at the time of purchase. Such tickets 10 include a barcode 12, depicted as a 2D barcode in FIG. 1. FIG. 2 depicts a generic scratch-off lottery ticket 10 having a play area 14 wherein game data is covered by a scratch-off layer 16. This ticket also includes a barcode 12 depicted as a 3D barcode in FIG. 2A. FIG. 2B depicts a 2D barcode 12 that may be provided on a lottery ticket having an additional security feature 16 in the form of a partial scratch-off layer 16 that is removed by the consumer or a clerk before the ticket can be redeemed. The barcode 12 depicted in FIG. 2C is a 3D barcode that also includes a security feature 16.

Barcodes 12 serve various purposes on lottery tickets, such as game identification, inventory, validation, and so forth. Generally, such barcodes include a generic portion that, for example, may simply identify the game the ticket relates to, and a ticket specific portion that provides a unique identification number to the ticket.

A concept of the present invention is that barcodes 12 typically used by manufacturers and game providers may vary from one lottery jurisdiction to the other, but are generally of a format that is easily recognizable as belonging to a lottery ticket as compared, for example, to a food product or other unrelated product. The formats of these barcodes 12 may vary within a given jurisdiction, as well as between different jurisdictions. For example, a lottery jurisdiction “A” may use three or four different types of barcode formats for the lottery tickets sold within its domain. Another lottery jurisdiction may use four or five different barcode formats for its tickets, and so forth. The same barcode formats may be used by different lottery jurisdictions. As an example, the Georgia Lottery (e.g., jurisdiction “A”) may issue scratch-off lottery tickets having a first barcode format, such as a 2D, 13-digit number formatted as a 3-digit game number followed by a ticket specific 10-digit validation number. The Georgia Lottery may also issue draw-type printed tickets with a different format, such as a 2D, 14-digit number formatted as a 4-digit game number followed by a ticket-specific 10-digit validation number. The Florida lottery may use a particular 3D format for draw game tickets and the same 2D format as Georgia for scratch-off tickets, and so forth.

It should thus be appreciated that the present method and system are not limited by the number and types of barcodes formats used in any given lottery jurisdiction.

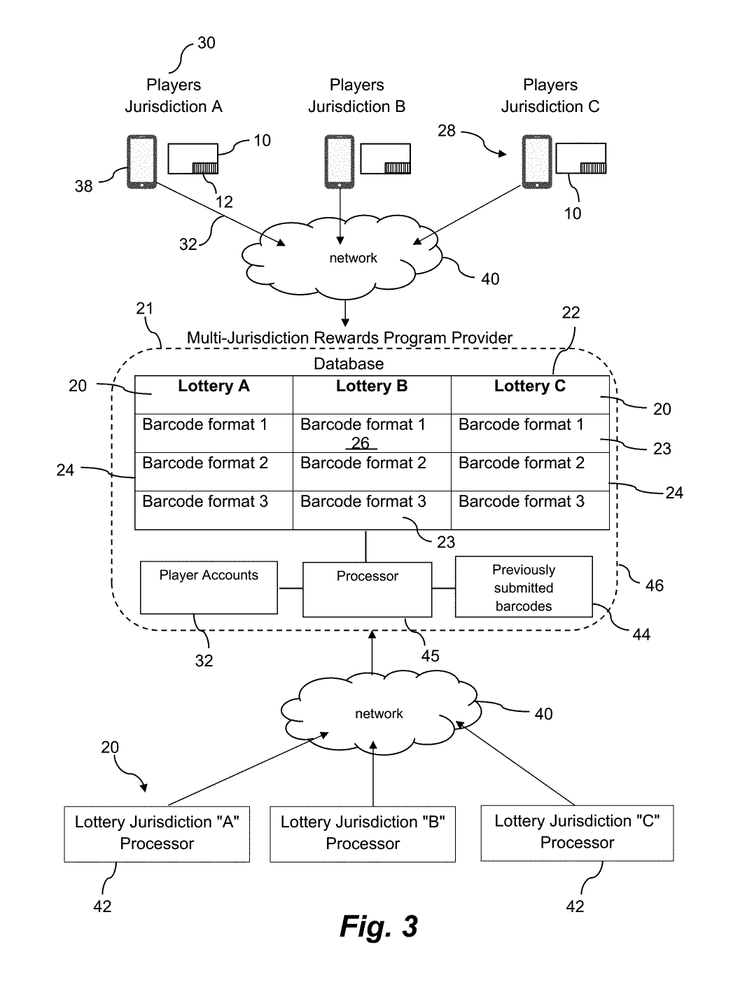

Referring to FIG. 3, rewards program may be implemented and maintained by a rewards program provider 21 entity that may or may not be the entity that also provides or administers the lottery games in the various jurisdictions 20. It should be appreciated that loyalty rewards program can be implemented without the active support or contribution of the individual lotteries, so long as the game provider 21 has the ability to maintain a current status of the different barcode 12 formats used on lottery tickets 10 by the various lotteries.

Still referring to FIG. 3, a special purpose computer database 22 is established and maintained by the rewards program provider 21. This database 22 includes a respective library 24 of the different lottery ticket barcode formats 23 used by each lottery jurisdiction 20 supported by the program. For example, FIG. 3 depicts three different lottery jurisdictions 20 supported by the program (jurisdictions “A”, “B”, and “C”), which may be different state lotteries in the United States. For illustrative purposes only, FIG. 3 depicts each jurisdiction as using three different types of lottery ticket barcode formats.

As mentioned, the actual informational content of the barcodes 12, such as the actual game number or actual ticket-specific validation number, need not be discerned from the barcode 12, but only the format 23 of the barcode. The method recognizes that lottery ticket barcode formats 23 are generally unique to lottery tickets and are not likely to be used on, for example, food products or other consumer items.

Preferably, at defined time intervals, the database 22 is updated with the current barcode formats 23 used in the different lottery jurisdictions 20. This step may be performed with or without the active participation of the respective lottery jurisdictions 20. For example, periodically, tickets from each of the lottery jurisdictions may be obtained, and the libraries updated with the formats 23 obtained directly from the tickets. Preferably, the lottery jurisdictions 20 are active participants in the loyalty rewards program and encourage their respective customers to enter and benefit from the program. In this case, as depicted in FIG. 3, the game provider processor 45 is in communication with the respective lottery jurisdiction processors 42 via a suitable wired or wireless communication network 40 for at least the purpose of receiving barcode format updates.

For entry into the loyalty program, the method provides an interface 28 for consumers 30 from the various lottery jurisdictions 20 to scan a barcode 12 from a lottery ticket 10 purchased in one of the lottery jurisdictions and transmit the scanned barcode image 32 to program processor 45 via a suitable communications network 40. The interface 28 may be single application-specific device that is provided to lottery players. In the illustrated embodiment, the interface 28 is a combination of the consumer's mobile smart device 48 (e.g., a smart phone) having scanning capability that runs a downloaded application made available by the program provider 21. The application configures the device 48 to scan the barcode 12 on the lottery ticket 10 and automatically transmit the scanned image 32 to the processor 45.

With the processor 45, the format of the scanned barcode 32 in the transmitted image is determined. The processor then compares the discerned format to the formats 23 stored in the library associated with the respective jurisdiction in which the lottery ticket 10 was sold. If the format of the scanned barcode matches one of the stored barcode formats 23, then the processor 45 credits an account 32 in the loyalty program created and assigned to the consumer with credit for the scanned lottery ticket 10. This “credit” may be in the form of points that can be redeemed by the consumer for any manner of goods or services, such as additional lottery tickets, merchandise, discounts at local retail establishments, and so forth.

In a particular embodiment, the application running on the interface device 28 (e.g., the smart phone 48) may prompt the consumer to enter (e.g., via a screen or keypad) the identity of the jurisdiction in which the lottery ticket was purchased prior to or after scanning the barcode from the lottery ticket, which enables the processor 45 to quickly search the appropriate library 24 in the database 22.

In an alternate embodiment, the identity of the jurisdiction 20 in which the lottery ticket 10 was purchased is identified in the scanned image of the barcode 12 transmitted to the processor 45. For example, referring to FIGS. 1 and 2A, the scanned image may 32 include a plain-text identifier 36 of the jurisdiction adjacent the barcode 12. In still another embodiment, the identity of the jurisdiction 20 is provided within the scanned barcode, for example with the game identifier or in a separate barcode prefix, wherein the processor is further configured to recognize the jurisdiction identity from the scanned barcode.

In still another embodiment, the identity of the jurisdiction 20 in which the lottery ticket 10 was most likely purchased can be based on the GPS location of the consumer's mobile device. The application running on the mobile device can also transmit the device's GPS position (if the mobile device is equipped with this capability) to the processor 45, which is configured to associate a given GPS system with the jurisdiction in which the GPS position lies.

In the event that a scanned barcode image 32 received by the processor 45 cannot be associated by the processor 45 with a library in the database, the received image is rejected by the processor and is not valid for credit in the loyalty program. Thus, even though the barcode 12 may be from a lottery ticket validly purchased by the consumer, if the jurisdiction in which the ticket 10 was purchased does not have a corresponding library 24 in the database 22, then the jurisdiction is “not supported” by the program and the entry is rejected by the processor 45.

In certain embodiments, the processor 45 may also perform a barcode validation check of the scanned barcode to ensure that the scanned barcode was not previously submitted. This step prevents multiple entry of the same lottery ticket 10 into the loyalty rewards program. The validation check can be performed in various ways. For example, the validation check may involve the processor comparing content of the actual barcode 12 to a database of previously submitted barcodes. In one embodiment, the processor may read the validation number portion of the barcode and determine if this number was previously submitted by comparison to a database 44 of previously submitted barcodes. This database 44 may also be divided by jurisdictions 20.

Embodiments of the methods disclosed herein may be executed by one or more suitable networked lottery gaming systems. Such system(s) may comprise one or more computing devices adapted to perform one or more embodiments of the methods disclosed herein. As noted above, such gaming systems and computing devices may access one or more computer-readable media that embody computer-readable instructions which, when executed by at least one computer, cause the computer(s) to implement one or more embodiments of the methods of the present subject matter. Additionally or alternatively, the computing device(s) may comprise circuitry that renders the device(s) operative to implement one or more of the methods of the present subject matter. Furthermore, components of the presently-disclosed technology may be implemented using one or more computer-readable media.

Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other memory devices, and the like.

The present disclosure also makes reference to the transmission of communicated data over one or more communications networks. It should be appreciated that network communications can comprise sending and/or receiving information over one or more networks of various forms. For example, a network can comprise a dial-in network, a local area network (LAN), wide area network (WAN), public switched telephone network (PSTN), the Internet, intranet or other type(s) of networks. A network may comprise any number and/or combination of hard-wired, wireless, or other communication links.

It should be appreciated by those skilled in the art that various modifications and variations may be made to the present invention without departing from the scope and spirit of the invention. It is intended that the present invention include such modifications and variations as come within the scope of the appended claims.

What is claimed is:

1. A computer-implemented method for implementing a loyalty program across multiple lottery jurisdictions, wherein each jurisdiction issues lottery tickets with one or more barcode formats, the method comprising:
creating a database that includes a library of the different lottery ticket barcode formats issued by each lottery jurisdiction;
at defined time intervals, updating the database with the current barcode formats used in the different jurisdictions;
for entry into the loyalty program, providing an interface for consumers from the various lottery jurisdictions to scan a barcode from a lottery ticket purchased in one of the lottery jurisdictions and transmit the scanned barcode image to a processor;
with the processor, comparing format of the scanned barcode in the transmitted image to the library of barcode formats; and
with the processor, crediting an account in the loyalty program assigned to the consumer with credit for the scanned lottery ticket only if the format of the scanned barcode matches one of the barcode formats saved in the database.

2. The method of claim 1, wherein the interface prompts the consumer to enter identity of the jurisdiction in which the lottery ticket was purchased prior to or after scanning the barcode from the lottery ticket, wherein the processor compares the scanned barcode to only the barcode formats saved in the library assigned to the identified jurisdiction.

3. The method of claim 1, wherein identity of the jurisdiction in which the lottery ticket was purchased is identified in the scanned image of the barcode transmitted to the processor, wherein the processor compares the scanned barcode to only the barcode formats saved in the library assigned to the identified jurisdiction.

4. The method of claim 3, wherein identity of the jurisdiction is provided by plain-text indicia adjacent the barcode on the lottery ticket.

5. The method of claim 3, wherein identity of the jurisdiction is provided in the scanned barcode, the processor configured to recognize the jurisdiction identity from the scanned barcode.

6. The method of claim 1, wherein the interface is implemented by an application downloaded to a consumer's network-enable device that is in communication with the processor, the application configuring the network-enabled device for scanning and transmission of the lottery ticket barcode to the processor.

7. The method of claim 6, wherein the identity of the jurisdiction is provided by a GPS signal from the network-enabled device that is transmitted with the scanned barcode image to the processor.

8. The method of claim 1, wherein the processor is in communication with a respective processor from each of the lottery jurisdictions, wherein the processor updates the database with the current barcode formats based on communications from the lottery jurisdiction processors.

9. The method of claim 1, wherein scanned barcode images received by the processor that cannot be associated by the processor with a library in the database are rejected by the processor as not valid for credit in the loyalty program.

10. The method of claim 1, wherein the processor also performs a barcode validation check of the scanned barcode to ensure that the scanned barcode was not previously submitted.

11. The method of claim 10, wherein the validation check comprises comparing content of the actual barcode in the scanned barcode image to a database of previously submitted barcodes.
